(19) United States
(12) Patent Application Publication
(10) Pub. No.: US 2012/0148337 A1
(43) Pub. Date: Jun. 14, 2012

(54) ROTATING ADAPTOR FOR A SIGN

(76) Inventor: Dean Dominic Delorenzo, Denver, CO (US)

(21) Appl. No.: 13/315,158

(22) Filed: Dec. 8, 2011

Related U.S. Application Data
(60) Provisional application No. 61/421,124, filed on Dec. 8, 2010.

(51) Int. Cl. G09F 7/22

(52) U.S. Cl. 403/164

(57) ABSTRACT

Embodiments of a rotating adaptor for a sign are disclosed. In one embodiment, a rotator adaptor rotationally attaches a secondary sign to a primary sign having a rigid frame. The rotator adaptor has a main body defining a notch therein bounded by three contiguous walls. A fastener is configured to couple the main body to the rigid frame of the primary sign. A bearing is coupled to a top surface of the main body. A shaft is coupled to the bearing and configured to rotate within the bearing and with respect to the primary sign, and to receive and couple with a secondary sign. The rotation of the shaft causes the secondary sign to rotate with respect to the primary sign.

### CROSS-REFERENCE TO RELATED APPLICATIONS

This application claims the benefit of U.S. Provisional Application No. 61/421,124 filed Dec. 8, 2010 entitled “Adapter to a sign frame that allows additional rider signs that are affixed to spin with the wind,” which is hereby incorporated by reference in its entirety.

### TECHNICAL FIELD

The subject matter described herein relates to signs, and more specifically to a rotating adaptor for a sign.

### BACKGROUND

Signs are often used to attract potential customers to a specific location. For some businesses, a single large, permanent sign can be used to attract customers, such as the tall, lighted (and sometimes moving) signs located on the premises of supermarkets and restaurants. In other industries, however, smaller, less expensive, portable signs are needed—such as in the real estate industry. These more modest signs, however, may fail to captivate potential customers.

To try to remedy the lackluster nature of such signs, various types of attachments have been used to help draw attention to the signs. One example of an attachment is a corrugated board that can be used as a rider. The rider is typically attached to the main sign in a fixed configuration, such that it does not move. Such fixed riders may do little other than enlarge the total surface area of the sign visible to potential customers.

The information included in this Background section of the specification, including any references cited herein and any description or discussion thereof, is included for technical reference purposes only and is not to be regarded subject matter by which the scope of the invention as defined in the claims is to be bound.

### SUMMARY

The various embodiments of a rotating adaptor for a sign disclosed herein allow a rider sign to be rotatably coupled to a main sign. For example, a rider sign can be rotationally mounted on a main sign, such that the rider spins or rotates with respect to the main sign. The rider may spin or rotate, for example, in response to gusts of wind. The spinning of the rider with the wind may help potential customers notice and be drawn to the sign.

In one embodiment, a rotator adaptor rotationally attaches a secondary sign to a primary sign having a rigid frame. The rotator adaptor has a main body defining a notch therein bounded by three contiguous walls. A fastener is configured to couple the main body to the rigid frame of the primary sign. A bearing is coupled to a top surface of the main body. A shaft is coupled to the bearing and configured to rotate within the bearing and with respect to the primary sign, and to receive and couple with a secondary sign. The rotation of the shaft causes the secondary sign to rotate with respect to the primary sign.

In another embodiment, the rotating adaptor has a linear main body. A fastener is configured to couple the linear main body to the rigid frame of the primary sign, and a bearing is coupled to a top surface of the linear main body. A shaft is coupled to the bearing and configured to rotate within the bearing and with respect to the primary sign and to receive a secondary sign. The rotation of the shaft causes the secondary sign to rotate with respect to the primary sign.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Other features, details, utilities, and advantages of the present invention as defined in the claims will be apparent from the following more particular written description of various embodiments of the invention and the illustrations thereof in the accompanying drawings.

### BRIEF DESCRIPTION OF THE DRAWINGS

FIG. 1 is an isometric view of a main sign with a rider sign rotatably coupled to the main sign via a rotating adaptor.

FIG. 2A is a side elevation view in cross section of an embodiment of a rotating adaptor for a sign.

FIG. 2B is a top plan view of the rotating adaptor of FIG. 2A.

FIG. 3A is a side elevation view of the shaft of the rotating adaptor of FIG. 2A.

FIG. 3B is a side elevation view of an alternate shaft that may be used in the rotating adaptor of FIG. 2A.

FIG. 4A is a side elevation view in cross section of another embodiment of a rotating adaptor for a sign.

FIG. 4B is a top plan view of the rotating adaptor of FIG. 4A.

FIG. 5A is a side elevation view in cross section of a further embodiment of a rotating adaptor for a sign.

FIG. 5B is a top plan view of the rotating adaptor of FIG. 5A.

### DETAILED DESCRIPTION

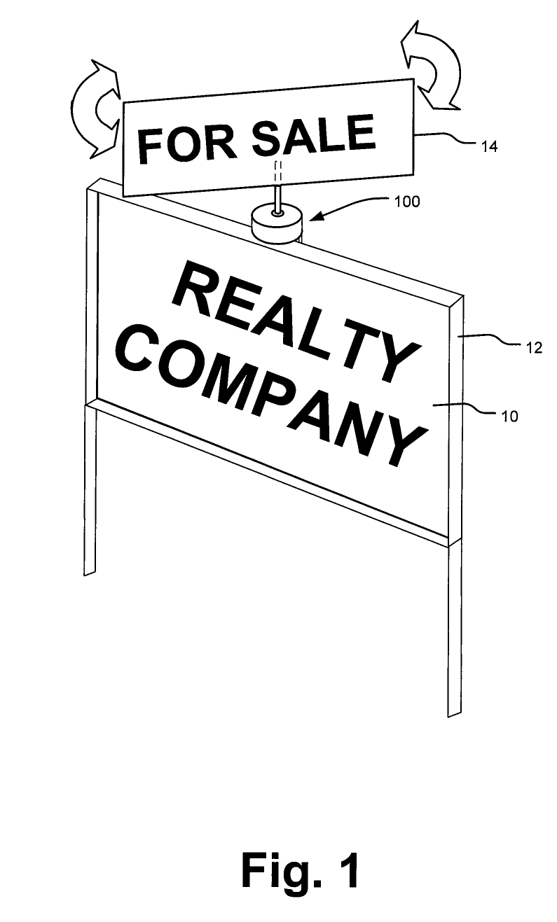

FIG. 1 shows an isometric view of a primary or main sign 10 with a rotating adaptor 100 rotatably coupling a secondary or rider sign 14 to the main sign 10. The main sign 10 may be, for example, a real estate sign, a political campaign sign, a promotional or identification sign for a business, and so forth. The main sign 10 may have a rigid frame 12 of flat or angle steel or other metal (or possibly plastic) around its perimeter, with a sheet of corrugated plastic, sheet of metal, or other type of sheet within the frame 12 of the main sign 10. The frame 12 may be approximately one-half inch wide, and may be approximately one-sixteenth or one-eighth of an inch thick. In some embodiments, the rotating adaptor 100 may couple the rider sign 14 to the main sign 10 by securing the rider sign 14 to the frame 12 of the main sign 10, as described in more detail below. The rider sign 14 may also be a self-supporting sheet of corrugated plastic, sheet of metal, or other type of sheet, or it may similarly be mounted within a frame (e.g., a flat frame).

As illustrated in FIG. 1, the main sign 10 is a real estate sign that may be used by a real estate agent to help sell a house. The main sign 10 may include the real estate agent's company and contact information, while the rider sign 14 may say “For Sale.” In other embodiments, however, the main sign 10 may say “For Sale,” and the rider sign 14 may indicate some particular feature of the house for sale—for example, the rider sign 14 may say “Move-in Ready” or “Fresh Paint” or “Price Reduced” and so forth. In still other embodiments, the main sign 10 and/or the rider sign 14 may not include any text. The rotating adaptor 100 may allow the rider sign 14 to rotate relative to the main sign 10. The rider sign may rotate because of, for example, wind gusts.

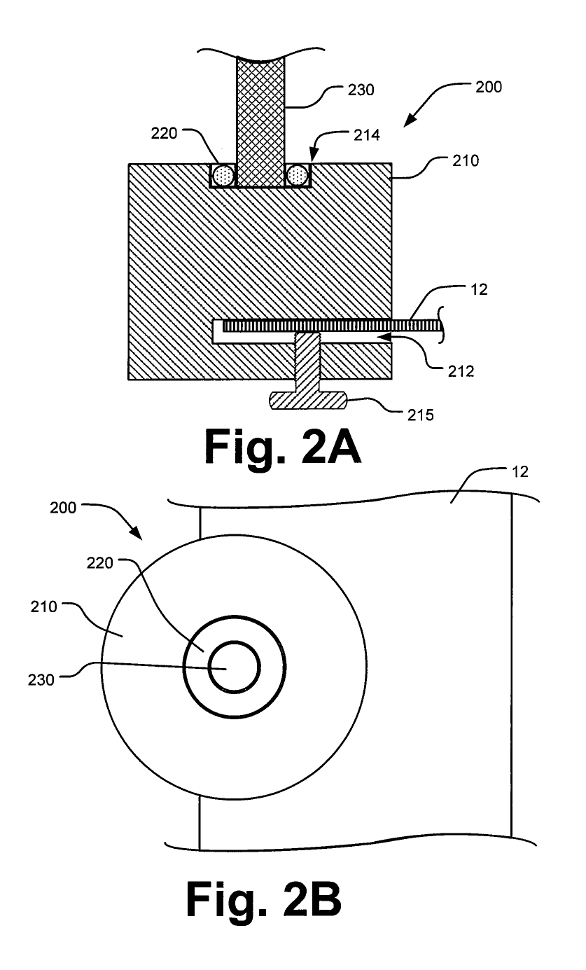

With reference to FIGS. 2A and 2B, one embodiment of a rotating adaptor 200 may include a main body 210. The main body 210 may be made from one or more materials, such as steel, aluminum, other types of metal, wood, plastic, and so forth. The main body 210 may have a generally cylindrical shape, and may be approximately one inch tall with a one inch diameter. Of course other sizes and shapes of a main body 210 may be used, depending on the size of the main sign 10 and the rider sign 14 to be coupled to the main sign 10. The main body 210 may be hollow or solid.

The main body 210 may include a horizontal notch 212 along the height of the main body 210 defined by three contiguous walls of the main body 210. The notch 212 may extend approximately one-fourth to three-fourths of the diameter of the cylinder in some embodiments. The height of the notch 212 may be greater than or approximately equal to the thickness of the frame 12 of the sign 10 to which the rotating adaptor 100 is to be coupled, so that at least a portion of the frame 12 of the sign 10 may be positioned within the notch 212. Two of the three contiguous walls may be opposing, parallel to, and spaced apart from each other with the third wall orthogonally spanning between the two parallel walls as an end wall. As explained in more detail below, a fastener 215 may secure the rotating adaptor 200 to the frame 12 of the main sign 10.

The main body 210 may also have a recess 214 into which a bearing 220 may be positioned. The recess 214 may generally be the same shape as the bearing 220, for example, a cylindrical shape. The bearing 220 may be a ball bearing, a roller bearing, a needle bearing, a spherical bearing, or a different type of bearing or other rotational mechanism. The bearing 220 may be coupled to the main body 210 by friction fit in some embodiments, whereas in other embodiments the bearing 220 may be coupled to the main body 210 by adhesive, welding, or by any suitable coupling mechanism.

A shaft 230 may be rotatably coupled to the bearing 220. The shaft 230 may be made from one or more materials, such as steel, aluminum, other types of metals, wood, plastic, and so forth. The shaft 230 may have a generally cylindrical shape, although the diameter of the shaft 230 may be less than the diameter of the main body 210. The height of the shaft 230 may depend on the desired height of the rider sign 14 that is to be coupled to the main sign 10, and other factors and may be, for example, between a half inch tall and seven inches tall, or shorter or taller.

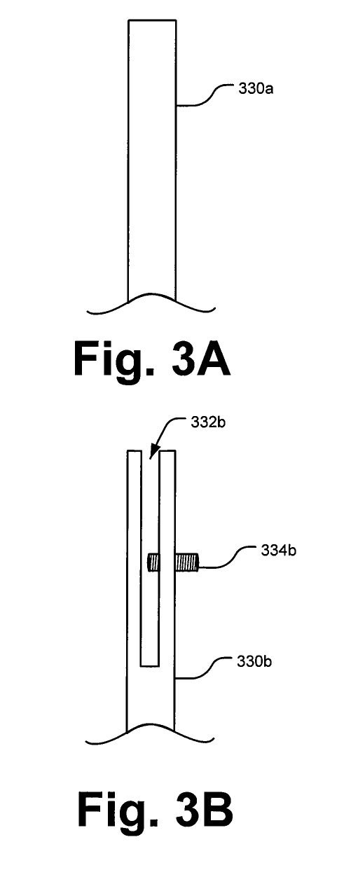

The shaft 230 may be positioned in the middle of the bearing 220, such that the bearing permits the shaft 230 to spin or rotate with respect to the main body 210. The shaft 230 may be coupled to the bearing 220 by friction fit in some embodiments, but may also be coupled to an interior surface of the bearing 220 by adhesive, welding, or by any suitable coupling mechanism. The shaft 230 may thus be coupled to the bearing 220, which is in turn coupled to the main body 210, which is in turn coupled to the frame 12 of the main sign 10 by the fastener 215. As explained below with reference to FIGS. 3A and 3B, a rider sign 14 may be coupled to the shaft 230. It should be noted that the rider sign 14 could similarly be any device or other attachment that can be mounted to the shaft 230 for rotational presentation above the main sign 10 and the term “rider sign” as used herein should be interpreted to include such other devices or attachments.

The fastener 215 may be a screw, a thumbscrew, a bolt, a clamp, or any other suitable fastener. The fastener may in some embodiments extend through a bottom wall of the rotator adaptor 200, e.g., through a threaded borehole, and may bias the frame 12 of the main sign 10 to an inner surface of the notch 212 by friction in some embodiments. Alternatively, the frame 12 of the sign 10 may have a hole through which the fastener may extend. In either of these embodiments, the rotator adaptor 200 may be removable and/or reusable. In other embodiments, however, a different type of fastener may be used, such as glue or a weld (not shown in FIG. 2A or 2B). In these embodiments, the rotator adaptor 200 may not be removable or reusable.

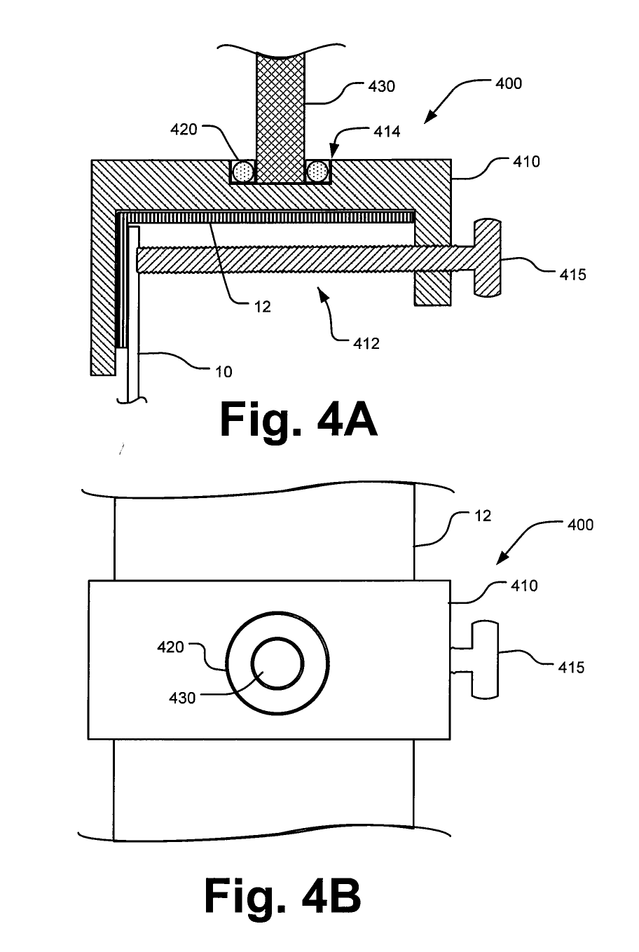

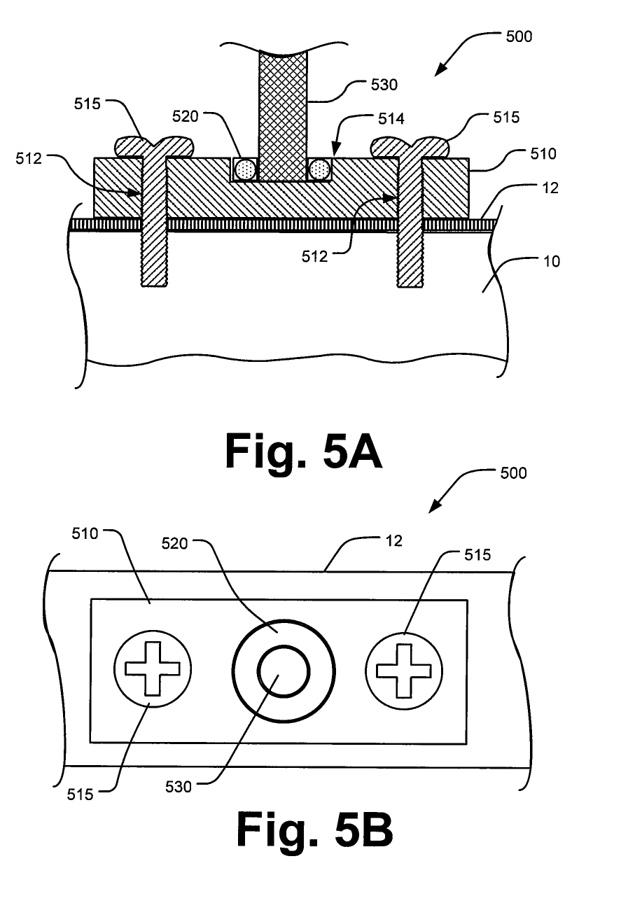

With reference to FIGS. 3A and 3B, two exemplary embodiments of a shaft 330a, 330b are illustrated. One of the shafts 330a, 330b, or a similar shaft may be used in the rotator adaptor 200 of FIGS. 2A and 2B (as well as the rotator adaptors 400, 500 of FIGS. 4A-4B and 5A-5B as further described below). As illustrated in FIG. 3A, a first embodiment of a shaft 330a may be generally cylindrical shaped and may not have a vertical notch, whereas a second embodiment of a shaft 330B, illustrated in FIG. 3B, may include at least one vertical notch 332b. In general, those shafts 330a without a vertical notch may be configured such that a rider sign (or other form of signage attachment) may be positioned over at least an upper portion of the shaft 330a. For example, the rider sign 14 may have a hole that is approximately the same size as the shaft 330a, into which the shaft 330a may be positioned. In a particular example, the shaft 330a may be sized with a diameter corresponding to a cross dimension of an internal void in a corrugated plastic material.

Alternatively, those shafts 330b with a vertical notch 332b may be configured such that a rider sign 14 may be positioned within the vertical notch 332b. For example, the rider sign 14 may be approximately the same thickness as the width of the notch 332b, and the rider sign 14 may be positioned within the notch 332b. In some but not all embodiments, a fastener 334b may bias the rider sign 14 against an interior surface of the vertical notch 332b. The fastener 334b may be, for example, a set screw, a bolt, a clamp, or another suitable fastener. In some embodiments, the fastener 334b may be temporary (e.g., a screw or bolt), whereas in other embodiments the fastener 334b may be more permanent (e.g., glue, a weld, etc.) (not illustrated). In still other embodiments, the shaft 330a, 330b may be manufactured together with the rider sign 14 (e.g., the rider sign 14 is manufactured with a shaft 330a, 330b extending from it) (not illustrated).

Also, those shafts 330b with a vertical notch 332b may alternatively be configured such that a rider sign may be positioned over at least an upper portion of the shaft 330b, even though the shaft 330b has the vertical notch 332b. For example, if the diameter of the shaft 330b is such that it can slide into a channel of a corrugated plastic board forming the rider sign 14 and create a friction fit therein, then the vertical notch 332b need not be used in such an implementation.

To install the rotating adaptor 200 with one or more shafts 330a, 330b, a user may loosen or otherwise unsecure the fastener 215 (when needed) in order to prepare the rotating adaptor 200 for installation. The user may then position at least a portion of the frame 12 of a main sign 10 into the horizontal notch 212. The portion of the frame 12 positioned within the horizontal notch 212 may extend into the horizontal notch 212 at least as far as needed so that the fastener 215, when fastened, biases the frame 12 against an upper surface (formed by one of the contiguous walls) of the horizontal notch 212. After at least a portion of the frame 12 is positioned within the horizontal notch 212, the user may fasten the fastener 215.

Next, a user may couple a rider sign 14 to the shaft 330a, 330b. If the rider sign 14 includes a hole configured to be positioned over the shaft 330a, 330b, the user may push the rider sign on the shaft 330a, 330b. If the rider sign 14 does not include a hole configured to be positioned over the shaft 330b, the user may loosen or otherwise unsecure the fastener 334b (when needed), position the rider sign 14 within the vertical notch 332b of the shaft 330b, and fasten the fastener 334b in order to secure the rider sign 14 within the vertical notch 332b.

To manufacture the rotating adaptor 200 with one or more shafts 330a, 330b, a solid cylinder of steel, aluminum, or other metal, for example, may be used. A recess 214 may be bored into a top surface of the solid cylinder, and a horizontal notch 212 may also be removed from the cylinder. Also, a threaded borehole or other opening in the lower wall of the cylinder may be made in some embodiments, through which the fastener 215 may extend. Next, a bearing 220 may be machine pressed into the recess 214, and a shaft 230, 330a, 330b may be machine pressed into the bearing 220.

With reference to FIGS. 4A and 4B, another embodiment of a rotating adaptor 400, similar to the rotating adaptor 200 described above in connection with FIG. 2, is presented. The rotating adaptor 400 may include a main body 410. The main body 410 may be made from one or more materials as previously described, and may have a C-shape similar to a beam clamp. The main body 410 may be approximately one square inch, although other sizes may of course be used, depending on the size of the main sign 10 and the rider sign 14 to be coupled to the main sign 10.

The main body 410 may define a wide, rectangular notch 412 along the width of the main body 410 bounded by three contiguous walls of the main body 410 with the open portion of the C-shape oriented downward. The notch 412 may be more than half of the width of the main body 410 (e.g., the notch may define the C-shape). In general, the notch 412 may be approximately large enough to be positioned over the frame 12 of the main sign 10. Two of the three contiguous walls may be opposing, parallel to, and spaced apart from each other with the third wall orthogonally spanning between the two parallel walls as an end wall. In some embodiments, the width of the notch may be approximately the same size as the width of the frame 12.

Like the rotating adaptor 200 described above, the rotating adaptor 400 in FIGS. 4A and 4B may include a recess 414 in a top surface thereof, a bearing 420 fitted into the recess 414, and a shaft 430. The shaft 430 may be rotatably coupled to the bearing, as above. Also like the rotating adaptor 200 described above, the rotating adaptor in FIGS. 4A and 4B may include a fastener 415, although the fastener 415 may be horizontally rather than vertically oriented. The fastener 415 may be a screw, a thumbscrew, a bolt, a clamp, or any suitable fastener. The fastener 415 may in some embodiments extend through a threaded borehole or other opening in the side wall of the main body 410 of the rotator adaptor 400 in order to secure the rotator adaptor 400 to the main sign 10. As above, the fastener 415 may be removable and/or reusable, or may be more permanent.

The installation of the rotating adaptor 400 may be similar to the installation of the rotating adaptor 200 described above in connection with FIG. 2, except that instead of positioning only a portion of the frame 12 of the main sign 10 within the horizontal notch 212 as in FIG. 2, the vertical notch 412 of the rotating adaptor 400 in FIG. 4 may be clamped around the entire width of the frame 12 in some embodiments. The fastener 415 may be fastened in order to prevent the rotating adaptor from falling off of the width of the frame 12 around which the rotating adaptor 400 is clamped.

The manufacture of the rotating adaptor 400 may also be similar to the manufacture of the rotating adaptor 200 described above in connection with FIG. 2, except that instead of boring a horizontal notch 212, a vertical notch 412 may be bored in the main body 410 of the rotating adaptor 400, and the opening for the fastener 415 may be made in a side wall of the main body 410 rather than in the lower wall.

With reference to FIGS. 5A and 5B, another embodiment of a rotating adaptor 500, similar to the rotating adaptor 200 described above in connection with FIG. 2 and/or similar to the rotating adaptor 400 described above in connection with FIG. 4, is presented. The rotating adaptor 500 may include a main body 510. The main body 510 may be made from one or more materials as previously described above, and may be formed as a generally linear plate or bar. The main body 510 may be approximately one inch wide, three inches long, and a half of an inch thick, although other sizes may of course be used, depending on the size of the main sign 10 and the rider sign 14 to be coupled to the main sign 10. The main body 510 may be rectangular as shown, but it may be formed in other appropriate shapes as well.

The main body 510 may not include a notch, but may include two or more boreholes 512 through which two or more fasteners 515 may be positioned. The holes may align with respective holes 512 on the frame 12 of the main sign 10. The fasteners 515 may be screws, bolts, clamps, or any other suitable type of fastener, and may serve to couple the rotating adaptor 500 to the frame 12 of the main sign 10. The fasteners 515 may extend through the holes 512 of the main body 510 of the rotating adaptor 500 and the frame 12 of the main sign 10. As above, the fasteners 515 may be removable and/or reusable, or may be more permanent. In the case of more permanent fasteners, such as adhesive, the main body 510 and/or the frame 12 may or may not have any holes; for example, neither the main body nor the frame 12 may have any holes, but the linear main body 510 may be coupled to the frame by adhesive.

Like the rotating adaptors 200, 400 described above, the rotating adaptor 500 in FIGS. 5A and 5B may include a recess 514 defined in a top surface thereof, a bearing 520 fitted within the recess 514, and a shaft 530. The shaft 530 may be coupled to the bearing 520, as above, such that the shaft rotates in conjunction with the bearing race in the bearing 520.

The installation of the rotating adaptor 500 may be similar to the installation of the rotating adaptors 200, 400 described above in connection with FIGS. 2 and 4, except that instead of positioning at least a portion of the frame 12 of the main sign 10 within the a notch 212, 412, the holes of the rotating adaptor 500 illustrated in FIG. 5 may be positioned above the holes in the frame 12 of the main sign 10, and two or more fasteners 515 may be used to secure the rotating adaptor 500 to the frame 12 of the main sign 10.

The manufacture of the rotating adaptor 500 may also be similar to the manufacture of the rotating adaptors 200, 400 described above in connection with FIGS. 2 and 4, except that instead of boring a notch 212, 412 and a hole for the fasteners 215, 415, two or more holes 512 may be bored in the main body 510 (and corresponding holes may be bored in the frame 12 of the main sign 10).

A variety of embodiments and variations of structures and methods are disclosed herein. Where appropriate, common reference numbers and words were used for common structure and method features. However, unique reference numbers and words were sometimes used for similar or the same structure or method elements for descriptive purposes. As such, the use of common or different reference numbers or words for similar or the same structural or method elements is not intended to imply a similarity or difference beyond that described herein.

All directional and relative references (e.g., upper, lower, upward, downward, left, center, right, side, lateral, front, middle, back, rear, top, bottom, above, below, vertical, and horizontal) are given by way of example to aid the reader's understanding of the particular embodiments described. They should not be read to be requirements or limitations, particularly as to the position, orientation, or use of the invention unless specifically set forth in the claims. Connection references (e.g., attached, coupled, connected, and joined, etc.) are to be construed broadly and may include intermediate members between a connection of elements and relative movement between elements unless otherwise indicated. As such, connection references do not necessarily infer that two elements are directly connected and in fixed relation to each other, unless specifically set forth in the claims. The exemplary drawings are for purposes of illustration only and the dimensions, positions, order and relative sizes reflected in the drawings attached hereto may vary.

The above specification, examples and data provide a complete description of the structure and use of exemplary embodiments of the invention as claimed below. Although various embodiments have been described above with a certain degree of particularity, or with reference to one or more individual embodiments, those skilled in the art could make numerous alterations to the disclosed embodiments without departing from the spirit or scope of the claims. For example, although the figures illustrate a rotating adaptor 100 coupling a rider sign 14 to an upper side of a frame 12 of a main sign 10, a rotating adaptor may be used along other sides of the frame 12, such as on the bottom side, left side, right side, and so forth, in addition to, or in place of on the upper side. Also, more than one rotating adaptor 100 may be used in some embodiments. As another example of an alteration, in the rotating adaptor 200 illustrated in FIG. 2, the main body 210 of the rotating adaptor 200 may not include a recess 214, but instead the bearing may be coupled to the outer surface of the upper wall of the main body 210 by, for example, welding or adhesives.

Still other embodiments and applications are therefore contemplated. It is intended that all matter contained in the above description and shown in the accompanying drawings shall be interpreted as illustrative only of particular embodiments and not limiting. Changes in detail or structure may be made without departing from the basic elements of the invention as defined in the following claims.

What is claimed is:

1. A rotator adaptor for a rotationally attaching a secondary sign to a primary sign having a rigid frame comprising
a main body defining a notch therein bounded by three contiguous walls;
a fastener configured to couple the main body to the rigid frame of the primary sign;
a bearing coupled to a top surface of the main body; and
a shaft coupled to the bearing and configured to rotate within the bearing and with respect to the primary sign and to receive and couple with a secondary sign;
wherein the rotation of the shaft causes the secondary sign to rotate with respect to the primary sign.

2. The rotator adaptor of claim 1, wherein the main body further defines a recess in the top surface and the bearing is positioned in the recess of the main body.

3. The rotator adaptor of claim 2, wherein the bearing is coupled to the main body within the recess by friction fit.

4. The rotator adaptor of claim 1, wherein the bearing is coupled to the main body by welding.

5. The rotator adaptor of claim 1, wherein a distance between two opposing walls of the three contiguous walls defining the notch is substantially equal to or greater than a dimension of the frame of the primary sign to which the rotator adaptor couples.

6. The rotator adaptor of claim 1, wherein the main body comprises metal.

7. The rotator adaptor of claim 1, wherein the horizontal notch extends into the main body by approximately one-fourth to three-fourths of the cross-sectional dimension of the main body.

8. The rotator adaptor of claim 1, wherein
the notch is a wide, rectangular notch defining a C-shape,
an open portion of the C-shape is oriented downward, and
the top surface of the main body to which the bearing is coupled oriented opposite the open portion oriented downward.

9. The rotator adaptor of claim 8, wherein one of two opposing walls of the three contiguous walls defines a threaded borehole configured to receive the fastener.

10. The rotator adaptor of claim 9, wherein the fastener comprises a thumbscrew.

11. The rotator adaptor of claim 8, wherein the notch is configured to clamp around the rigid frame of the primary sign.

12. The rotator adaptor of claim 1, wherein the main body is generally cylindrical shaped and two opposing walls of the three contiguous walls are parallel to the top surface of the main body to which the bearing is coupled.

13. The rotator adaptor of claim 1, wherein two opposing walls of the three contiguous walls are perpendicular to the top surface of the main body to which the bearing is coupled.

14. The rotator adaptor of claim 13, wherein one of the two opposing walls defines a threaded borehole configured to receive the fastener.

15. The rotator adaptor of claim 1, wherein the shaft includes a vertical notch configured to receive within the vertical notch the secondary sign.

16. The rotator adaptor of claim 15, wherein the fastener is a first fastener, and wherein the shaft further includes a second fastener configured to bias the secondary sign to an interior surface of the vertical notch.

17. The rotator adaptor of claim 1, wherein the shaft is substantially cylindrical shaped and is configured to be received in an internal void of the secondary sign.

18. A rotator adaptor for rotationally attaching a secondary sign to a primary sign having a rigid frame comprising
a linear main body;
a fastener configured to couple the linear main body to the rigid frame of the primary sign;
a bearing coupled to a top surface of the linear main body; and
a shaft coupled to the bearing and configured to rotate within the bearing and with respect to the primary sign and to receive a secondary sign;
wherein the rotation of the shaft causes the secondary sign to rotate with respect to the primary sign.

19. The rotator adaptor of claim 18, wherein the fastener is a first fastener, and further comprising a second fastener, further wherein the linear main body includes two boreholes configured to receive the first and second fasteners for attachment of the main body to the rigid frame of the primary sign.

20. The rotator adaptor of claim 18, wherein the linear main body further defines a recess in the top surface and the bearing is positioned in the recess of the main body.
